(19) United States
(12) Patent Application Publication
(10) Pub. No.: US 2022/0029449 A1
(43) Pub. Date: Jan. 27, 2022

(54) Luggage Having Charging Port

(71) Applicant: Traveller's Club Luggage, Inc., La Palma, CA (US)

(72) Inventor: Peter Dalsoo Yu, La Palma, CA (US)

(21) Appl. No.: 17/191,505

(22) Filed: Mar. 3, 2021

Related U.S. Application Data
(63) Continuation of application No. 15/439,582, filed on Feb. 22, 2017, now abandoned.

(51) Int. Cl. H02J 7/34; A45C 5/14; A45C 5/03; A45C 15/00; H02J 7/00

(52) U.S. Cl. CPC H02J 7/342; A45C 5/14; A45C 5/03; A45C 2013/025; H02J 7/0013; H02J 7/0042; A45C 15/00

(57) ABSTRACT

The present invention discloses a suitcase having an outer shell having two opposite side shells, wherein a first USB interface is provided on the side shells of the suitcase, and an open end of the first USB interface faces outside of the suitcase, and a non-open end of the first USB interface faces inside of the suitcase and is electrically connected to a second USB interface by a cable, and a second storage bag for placing a power source connected to the second USB interface is provided on an inner surface of the side shell. When the suitcase disclosed is in use, by placing the mobile power pack into the second storage bag and electrically connecting it to the USB interface, and connecting the mobile terminal with the first USB interface, it can realize the charging of the mobile terminal without opening and closing the suitcase.

### CROSS REFERENCE TO RELATED APPLICATION

This application is a continuation of pending: U.S. patent application Ser. No. 15/439,582, filed Feb. 22, 2017, and entitled “Luggage Having Charging Port (2 in 1)”, the contents of which are incorporated herein by reference.

### BACKGROUND OF THE INVENTION

A suitcase is one of the travel essentials. When people travel, a mobile power pack is often placed inside the suitcase in order to charge mobile terminals, such as mobile phones. In the prior art, when the mobile power pack inside the suitcase is to be used, it is necessary to open the case, which is cumbersome. If the mobile power pack is used outside the case, it is inconvenient to place both the power pack and the mobile terminal. Instead, if the mobile terminal is placed inside the case along with the mobile power pack, the demand for charging can be satisfied, however, the using demand of mobile terminal cannot be met at the same time. In short, it is very inconvenient for the existing suitcase to charge the mobile terminal.

### BRIEF SUMMARY OF THE INVENTION

The technical problem to be solved in the present invention is to overcome the defect of the charging inconvenience of the existing suitcase by providing a suitcase.

The present invention solves the above technical problem by providing the following proposal:

A suitcase comprising an outer shell having two opposite side shells, wherein a first USB interface is provided on a side shell of the suitcase, and an open end of the first USB interface faces outside of the suitcase, and a non-open end of the first USB interface faces inside of the suitcase and is electrically connected to the second USB interface by a cable, and a second storage bag for placing a power source connected to the second USB interface is provided on an inner surface of the side shell.

Preferably, the non-open end of the first USB interface lies inside the second storage bag, and the second storage bag has a bag mouth.

With the above arrangement, the distance between the power source in the second storage bag and the first USB interface can be relatively short, so that the length of the cable 300 is relatively short, which save the inner space of suitcase.

Preferably, a zipper for closing the bag mouth is provided at the bag mouth.

With the above arrangement, the second storage bag and the inner surface of the side shell may form an enclosed space, and the normal operation of the power source in the second storage bag won't be affected by placing the suitcase vertically or horizontally.

Preferably, a first storage bag for placing the mobile terminal electrically connecting to the first USB interface is provided at the outer surface of the outer shell, and the first storage bag and the first USB interface are located at the same side of the outer shell.

With the above arrangement, the mobile terminal to be charged can be placed in the first storage bag, which is more convenient for charging, and other articles such as water bottles can also be placed in the first storage bag, which further increases the convenience of the suitcase.

Preferably, the open end of the first USB interface lies outside of the first storage bag.

With the above arrangement, the articles in the first storage bag do not interfere with the first USB interface.

Preferably, the side shell is provided with a mounting hole and the suitcase further comprises an interface support base having a support hole, and the first USB interface passes through the mounting hole and the support hole, and the interface support base, side shell and the non-open end of the first USB interface are fixedly connected, and the side shell lies between the interface support base and the non-open end of the first USB interface.

Preferably, the interface support base, the side shell and the non-open end of the first USB interface are fixedly connected using threaded fasteners, and the interface support member is preferably made of plastic cement or plastic.

Preferably, the suitcase further comprises an interface support member, which has an interface support sleeve and an interface cover fixedly connected together, wherein the interface support sleeve surrounds the first USB interface and passes through the mounting hole and the support hole, and the interface cover is used for closing the open end of the first USB interface.

With the above arrangement, the interface cover can be closed when not being used for charging, so as to prevent dust from entering and protect the first USB interface.

Preferably, the interface support sleeve of the interface support is formed integrally with the interface cover, and the interface support member is made of silicone and the interface support sleeve is bonded to the interface support base.

Preferably, the first USB interface is located in the upper portion of the side shell.

The above-mentioned preferred conditions may be arbitrarily combined to obtain the preferred embodiments of the present invention, in accordance with the common knowledge in the art.

The positive progress effect of the present invention is that:

When the suitcase is in use, by placing the mobile power pack into the second storage bag and electrically connecting it to the USB interface, and connecting the mobile terminal with the first USB interface, it can realize the charging of the mobile terminal without opening and closing the suitcase, and meet the charging needs and the use demand, thus it is easy to operate.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a lateral structural schematic view of the suitcase with the interface cover opening according to a first embodiment.

FIG. 2 is a partial enlarged schematic view of part A in FIG. 1.

FIG. 3 is a structural schematic view of the side plate of the suitcase according to the first embodiment.

FIG. 4 is an inner structural schematic view of the suitcase according to the first embodiment, wherein the mobile power pack is placed in the second storage bag.

FIG. 5 is a lateral structural view of the suitcase according to a first embodiment of the present invention, wherein the mobile terminal is placed in the first storage bag.

FIG. 6 is a lateral structural schematic view of the suitcase according to the first embodiment, wherein the bottle is placed in the first storage bag.

FIG. 7 is a lateral structural schematic view of the suitcase with interface cover closing according to the first embodiment.

FIG. 8 is an inner structural schematic view of the suitcase according to a second embodiment.

### LIST OF REFERENCE SIGNS

100: suitcase

110: outer shell

111: side shell

200: first USB interface

210: open end

220: non-open end

250: first storage bag

300: cable

400: second USB interface

450: second storage bag

451: bag mouth

452: zipper

500: interface support base

510: support hole

550: interface support member

551: interface support sleeve

552: interface cover

600: mobile power pack

700: mobile terminal

800: bottle

### DETAILED DESCRIPTION OF THE INVENTION

The preferred embodiments will be described combined with figures to illustrate the present invention more precisely and completely.

### EXAMPLE 1

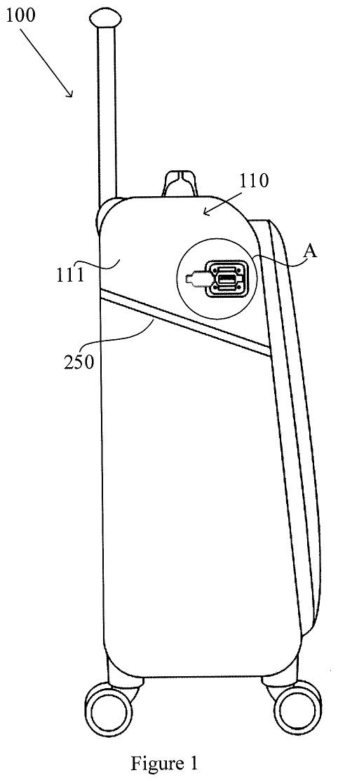

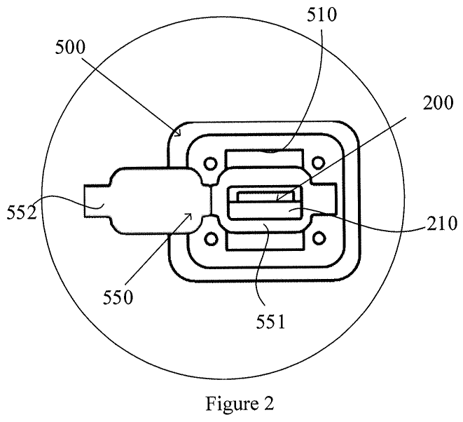

As shown in FIGS. 1-4, the present invention provides a suitcase 100, comprising an outer shell 110 having two opposite side shells 111. A first USB interface 200 is provided on the side shell 111 of the suitcase 100. The open end 210 of the first USB interface 200 faces outside of the suitcase 100. The non-open end 220 of the first USB interface 200 faces inside of the suitcase 100 and electrically connects to a second USB interface 400 by a cable 300. A second storage bag 450, for accommodating the power source electrically connecting to the second USB interface 400 is provided on the inner surface of the side shell 111.

The first USB interface 200 is located at the upper portion of the side shell 111, which facilitates the operation of the first USB interface by users.

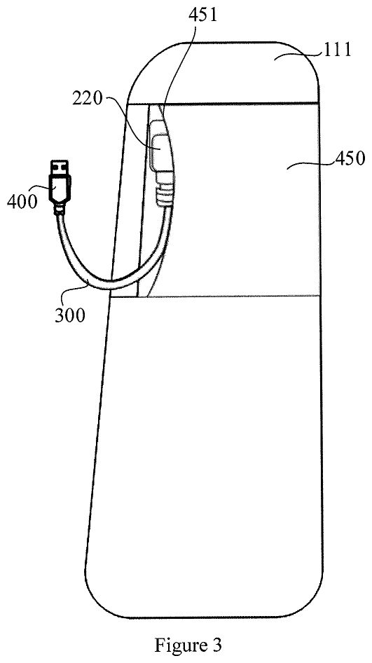

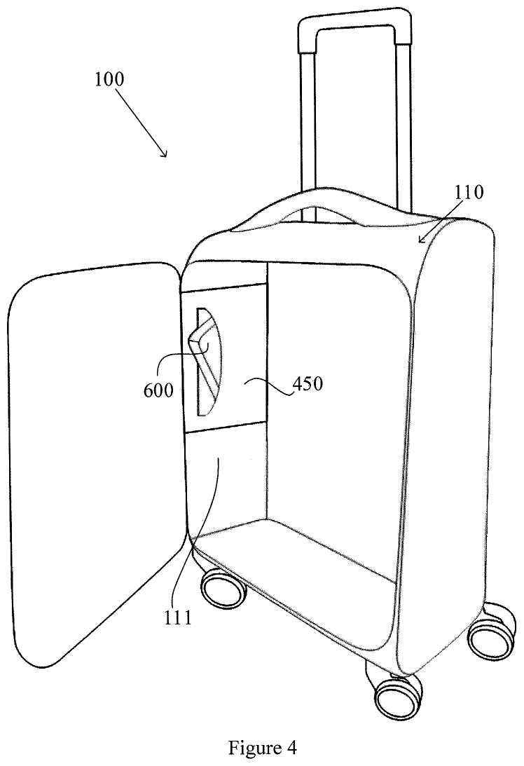

The non-open end 200 of the first USB interface 200 is located inside the second storage bag 450 having a bag mouth 451, as shown in FIG. 3. The power source, i.e., mobile power pack 600, is placed in the second storage bag 450, as shown in FIG. 4. The distance between the power source in the second storage bag 450 and the first USB interface 200 is relatively short, so that the length of the cable 300 is also relatively short, which saves the inner space of suitcase 100.

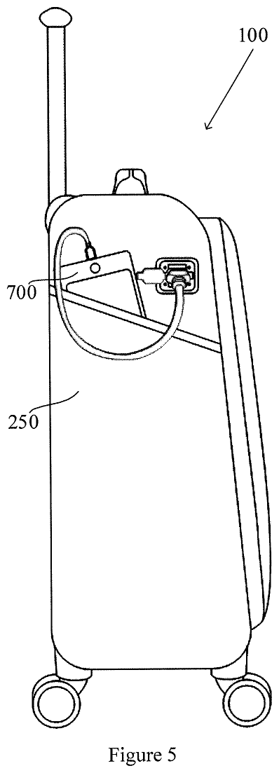

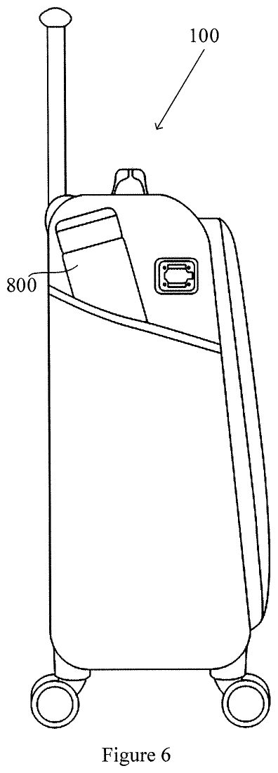

The outer surface of the outer shell 110 is also provided with a first storage bag 250, as shown in FIGS. 5-6. The first storage bag 250 for accommodating the mobile terminal 700, such as a cell phone or other mobile electronic device, electrically connecting to the first USB interface 200 and the first USB interface 200 are located at the same side shell 111 of the outer shell 110. As shown in FIG. 5, the mobile terminal 700 to be charged is located in the first storage bag 250, which facilitates charging. Articles such as bottles 800 may also be placed in the first storage bag 250, as shown in FIG. 6. The first storage bag 250 further increases the convenience of the suitcase 100.

In the present embodiment, the open end 210 of the first USB interface 200 is located outside the first storage bag 250, so that the articles inside the first storage bag 250 do not cause any interference with the first USB interface 200. In other embodiments, the open end 210 of the first USB interface 200 may also be located in the first storage bag 250.

Referring to FIGS. 1-4 again, the side shell 111 is provided with a mounting hole (not shown). The suitcase 100 also comprising interface support base 500 provided with a support hole 510. The first USB interface 200 is inserted through the mounting hole and the support hole. The interface support base 500, side shell 111 and the non-open end 220 of the first USB interface 200 are fixedly connected, and the side shell 111 lies between the interface support base 500 and the non-open end 220 of the first USB interface 200.

The interface support base 500, the side shell 111 and the non-open end 220 of the first USB interface 200 are fixedly connected by threaded fasteners. The interface support base 500 is preferably made of plastic cement or plastic. In the present embodiment, four threaded fasteners are provided to achieve the fixation, but in the other embodiments, three or five threaded fasteners can be provided.

The suitcase 100 further comprises an interface support member 550 having an interface supporting sleeve 551 and an interface cover 552 being fixedly connected together. The interface sleeve 551 surrounds the first USB interface 200. The interface support sleeve 551 is arranged between the mounting hole and the support hole 510, and the interface cover 552 is used for closing the open end 210 of the first USB interface 200. The interface support sleeve 511 of the interface support member 550 is formed integrally with the interface cover 552. The interface support member 550 is made of silicone and the interface support sleeve 551 is bonded to the interface support base 500.

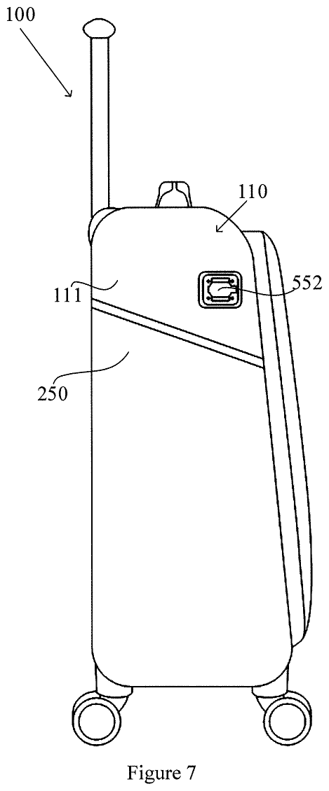

As shown in FIG. 7, it can achieve the purpose of protecting the first USB interface 200 by closing the interface cover 552 when not charging so as to prevent dust.

When the suitcase 100 is in use, the mobile power pack 600 is placed in the second storage bag 450 and electrically connected to the second USB interface 400, and the mobile terminal 700 is electrically connected to the first USB interface 200, so as to charge the mobile terminal 700 without opening and closing the suitcase, and meet the demands for using and charging simultaneously, and operate conveniently. The mobile terminal 700 is placed in the first storage bag 250 and can be taken out and used at any time.

### EXAMPLE 2

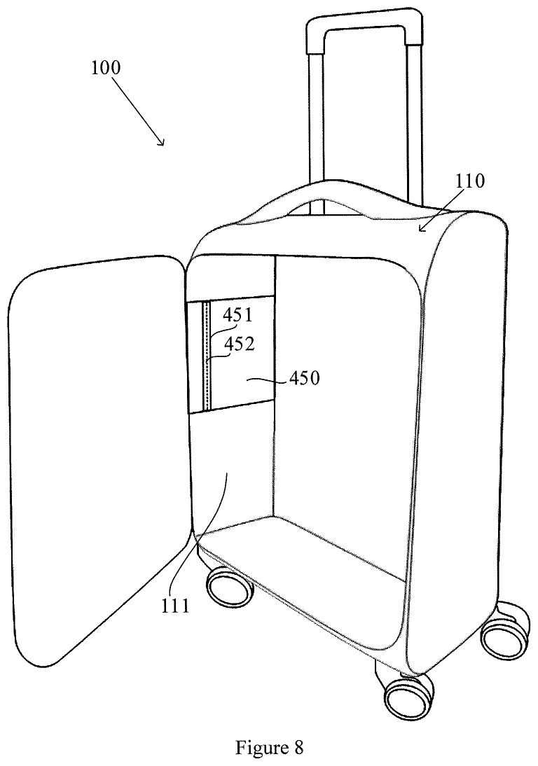

The configuration of the suitcase 100 in the embodiment shown in FIG. 8 is substantially as same as that of the first embodiment, and the difference is that a zipper 452 for closing the bag mouth 451 is provided at the bag mouth 451. The second storage bag 450 and the inner surface of the side shell 111 can form an enclosed space, and the normal operation of the power source in the second storage bag 450 won't be affected by placing the suitcase 100 vertically or horizontally.

It should be understood that, in the description, terms used to reference the orientation or positional relationship are based on the orientation or positional relationship in the drawings, such as “upper”, “lower”, “front”, “rear”, “left”, “right”, “vertical”, “horizontal”, “bottom”, “inner”, “outer”, etc., and they are only used to facilitate the description of the present invention and simplify the description, but not to indicate or suggest the specific orientation of the arrangement or member or to suggest it must be configured or operated in a specific orientation, and therefore, they should not be deemed as limiting the present invention.

Although specific embodiments of the present invention have been described above, but it should be understood by the skilled in the art that those are merely illustrations, and the scope of protection of the present invention is defined by appended claims. It will be apparent to those skilled in the art that variants and modifications can be made in the embodiments without departing from the principles and essential characteristics of the present invention, and these variants and modifications are within the scope of the present invention.

What is claimed is:

1. A suitcase, comprising an outer shell having two opposite side shells, wherein a first USB interface is provided on one of the two side shells of the suitcase; and an open end of the first USB interface faces outside of the suitcase, and a non-open end of the first USB interface faces inside of the suitcase and is electrically connected to a second USB interface by a cable, and a power source storage bag for placing a power source connected to the second USB interface is provided on an inner surface of the side shell on which the first USB interface is provided.

2. The suitcase according to claim 1, wherein the non-open end of the first USB interface lies inside the power source storage bag, and the power source storage bag has a bag mouth.

3. The suitcase according to claim 2, wherein a zipper for closing the bag mouth is provided at the bag mouth.

4. The suitcase according to claim 1, wherein a first storage bag for placing a mobile terminal electrically connecting to the first USB interface, is provided at an outer surface of the outer shell, and the first storage bag and the first USB interface are located at the same side of the outer shell.

5. The suitcase according to claim 4, wherein the open end of the first USB interface is outside of the first storage bag.

6. The suitcase according to claim 1, wherein the side shell having the first USB interface is provided with a mounting hole and the suitcase further comprises an interface support base having a support hole, and the first USB interface passes through the mounting hole and the support hole; and the interface support base, the side shell having the first USB interface and the non-open end of the first USB interface are fixedly connected, and the side shell having the first USB interface lies between the interface support base and the non-open end of the first USB interface.

7. The suitcase according to claim 6, wherein the interface support base, the side shell having the USB interface and the non-open end of the first USB interface are fixedly connected by threaded fasteners.

8. The suitcase according to claim 6, wherein the suitcase further comprises an interface support member, which has an interface support sleeve and an interface cover fixedly connected together, wherein the interface support sleeve surrounds the first USB interface and passes through the mounting hole and the support hole, and the interface cover is used for closing the open end of the first USB interface.

9. The suitcase according to claim 8, wherein the interface support sleeve of the interface support is formed integrally with the interface cover, wherein the interface support member is made of silicone, and the interface support sleeve is bonded to the interface support base.

10. The suitcase according to claim 1, wherein the first USB interface is located in an upper portion of the side shell having the first USB interface.
